(19) United States
(12) Patent Application Publication
(10) Pub. No.: US 2002/0120619 A1
(43) Pub. Date: Aug. 29, 2002

(54) Automated categorization, placement, search and retrieval of user-contributed items

(75) Inventors: Larry S. Marso, San Jose, CA (US); Brian E. Litzinger, Los Gatos, CA (US)

Correspondence Address: David H. Jaffer, Pillsbury Winthrop LLP, 2550 Hanover Street, Palo Alto, CA, 94304-1115, US

(73) Assignee: High Regard, Inc.

(21) Appl. No.: 09/956,585

(22) Filed: Sep. 17, 2001

Related U.S. Application Data
(63) Continuation-in-part of application No. 09/723,666, filed on Nov. 27, 2000.
(60) Provisional application No. 60/232,952, filed on Sep. 15, 2000.
(60) Provisional application No. 60/167,594, filed on Nov. 26, 1999.

(51) Int. Cl. G06F 7/00; G06F 17/30; G06F 15/16

(52) U.S. Cl. 707/3; 709/203

(57) ABSTRACT

A method for computerized interactive search and retrieval of content items, in which contributed content items are separated into discrete classifications, provided to users, evaluated by certain users, and assigned a quality rating based on weightings of the evaluations.

### RELATED APPLICATIONS

This application claims priority form U.S. Provisional Patent Application Serial No. 60/232,952 filed on Sep. 15, 2000, and is a continuation in part of U.S. patent application Ser. No. 09/723,666 filed on Nov. 27, 2000 (which claims priority from U.S. Provisional Patent Application Serial No. 60/167,594 filed on Nov. 26, 1999). The disclosures of each of the foregoing priority applications is incorporated herein by reference.

### REFERENCES

This provisional application references the Bag of Words Library (referred to herein as “libbow”): McCallum, Andrew Kachites. “Bow: A toolkit for statistical language modeling, text retrieval, classification and clustering,” http://www.cs.cmu.edu/˜mccallum/bow, 1996, which is published under the terms of the GNU Library General Public License, as published by the Free Software Federation, Inc., 675 Mass Ave., Cambridge, Mass. 02139.

### BACKGROUND ON THE PRIOR ART

On wide area networks such as the Internet or corporate intranets, user contributions are often made available to broad, decentralized audiences. For example, in the context of online forums and other platforms for group collaboration, users contribute new messages, postings or other items to existing collections of items made widely available to other users. It is important that users with common interests have an opportunity to review and respond to groupings of related items, as a form of dialog or collaboration.

Collections of user-contributed items, and each newly contributed item, must therefore be categorized or indexed in some manner to facilitate efficient access by other users.

There are three general approaches taken in the prior art.

One approach to categorization requires decisionmaking by users at the moment they contribute content, and a corresponding effort by users accessing content. A user selects and transmits items to (or retrieves items from) a network node that is known to accumulate and redistribute items in a defined category, such as the server for a mailing list on a specialized topic, a decentralized Usenet server or a groupware platform. Or the user intercommunicates with a network node offering alternative collections or paths to collections of content, traverses a hierarchy of categories and subcategories, and identifies an appropriate forum or groupware category for making a contribution (or accessing content), such as a web site or intranet hosting multiple, special purpose discussion groups or knowledge bases.¹ ¹ Users identify such facilities, for example, through word of mouth, search engines or web browsing, in the pursuing of content in categories they are interested in, or receive access to such facilities in the course of their employment.

Another approach to categorization requires decisionmaking by third parties when users contribute content and, in theory, a simpler effort by the users accessing content. Editors or moderators are positioned at a node (or group of related nodes) on a wide area network and accept user contributions, conduct a review or vetting procedure—possibly exercising discretion to edit or rewrite items—and undertake the placement of items within a hierarchy of categories that they define and manage. Among their objectives are improving quality, simplifying data access and retrieval, and increasing the likelihood of further dialog and collaboration. Examples include mailing list moderation by volunteers, the centralized editorial fimctions of a web site serving a specific category of content or commerce, or staff management of a corporate knowledge base.

These first two approaches require the definition of subject matter at the outset and refinement over time, and may involve the construction of a hierarchy of categories by a central authority. Judgments about the scope and granularity of subject matter requires the balancing of competing objectives. Ease of use requires a limited number of categories. However, if the subject matter is too general, forums and collaborative environments may fail to develop cohesive discussions and prove less useful. At the same time, multiplying the number of categories can be taken too far. If too specialized, forums and collaborative environments may fail to achieve critical mass and continuity. Further, in the case of moderation or the editorial or staff placement of items, the administrative burden multiplies as the number of categories grows.

Typically, high volume forums and collaborative environments on wide area networks are defined by relatively narrow subject matter, either explicitly or in context.² Applications involving heavy moderation or editorial and staff placement of items tend to be low-to-medium volume. ² A forum with a seemingly general topic, for example “relationships”, positioned on a web site with narrow user demographics, such as women between 16 and 21 years of age, might have a more limited range of topics than a similarly entitled forum on a web site with a broader audience. By contrast, the Usenet forum “rec.photo.technique.people”, which suggests specialization by its title, enjoys significant variation among posting topics. The techniques discussed span portrait taking, sports photography and fashion pictures, in part because there are no separate Usenet forums for these interests.

A third approach to categorizing or indexing user-contributed items is the use of automated means, such as search engines that serve up items in response to key words or natural languages questions, or similar embedded applications.³ ³ An example of an embedded application is a knowledge base of customer support correspondence, containing user contributions by customers and staff, integrated in a comprehensive customer relationship management suite.

Automated means of indexing (and retrieving) user-contributed items typically utilize pairwise comparison, which attempts to find the best individual item matches for a query or a new item of content, based on factors such as term overlap, term frequency within a document, and term frequency among documents. Such indexing methods do not typically categorize items at the time they enter the system, but rather store “tokenized”, reduced form representations suited for efficient pairwise comparison on-the-fly. Examples of pairwise comparison in the area of user-contributed content include the search engine of the Deja Usenet archive, and its successor, Google Groups, in the form at which the service entered public beta in 2001. Another example is the emerging category of corporate knowledge bases providing natural language search engines for documents created by staff on a variety of productivity applications (which may themselves store information in proprietary and incompatible formats).

Automated methods of categorizing user-contributed items typically rely on statistical and database techniques known as “cluster analysis”, which determine the conceptual “distance” between individual items based on factors such as term overlap, term frequency within a document, and term frequency among documents. With these techniques, it is possible to take large collections of unclassified items and produce a classification system based on machine estimates of concept “proximity”. It is also possible to take already classified items (whether by human efforts, automated means or some combination) and predict the appropriate classification for a query or new item of content. An example of this is a customer relationship management system that performs cluster analysis on historical e-mails, then automatically categorizes incoming e-mail and sends it along to staff associated with the category.

Demonstrating the deficiency of the prior art, even with the application of all the above methods, users must often review mountains of user-contributed content that is poor, offensive, unrelated to their interests or reflecting commercial bias, before finding items that fully meet their needs. Indeed, few users have the time and ability to perform such a review, which may require constant attention to a rapid stream of content flowing through traditional forums, traversing elaborate hierarchies of content with no assurance of success, relying on the editorial efforts (and seeing through the bias) of centralized media sources, or coping with search engines that are mostly blind to quality considerations.

Worse, to the extent that some users spend time and effort identifying quality items for their own consumption, other users generally do not benefit, and either end up duplicating the effort or abandoning it altogether.

Users have few tools at their disposal that improve the situation. They may be able to selectively block items from users whose contributions they wish to avoid entirely,⁴ or report evidence of abuse to administrators of the service or collaboration environment, or post a response that attempts to alert others to problematic content. In some cases, “average” ratings of an author's previous contributions (typically based on sparse ratings assigned by unknown users) may be available, to which one can add another rating. ⁴ E.g., Usenet application “killfile” technology.

Search technology alone is a poor substitute for quality control. Relevancy and concept proximity are only loosely related to the quality of content in many, if not most situations. In fact, given a reliable measure of quality, it is likely that many users would sacrifice some element of relevancy or concept proximity for higher quality content.

### SUMMARY AND OBJECTS OF THE PREFERRED EMBODIMENTS

In view of the foregoing shortcomings of prior art, it should be apparent that there exists a need in the art for enhancements that incorporate additional quality control features into categorization and search technologies. Particularly absent from the prior art are robust methods of tapping the expertise of contributing users as a means of quality control, in applications that categorize and index user-contributed items by automated means.

In a related patent application, we have set forth methods of general application for rating users, user-contributed items and groupings of user-contributed items, including Expertise, Regard, Quality, Caliber, related methods and user-interface innovations.⁵ These methods ⁵ U.S. patent application Ser. No. 09/723666, filed Nov. 27, 2000, and the U.S. Provisional Patent Application under which it claims priority (Serial No. 60/167,594, filed Nov. 26, 1999), entitled: give more weight to ratings offered by users who have, themselves, contributed highly rated items. In practice, these methods enable expert user-contributors to identify quality content—for their own benefit and the benefit of all users—without any centralized effort to identify experts in the first place.

The invention applies these methods in the context of categorizing, indexing and accessing user-generated content.

In an improvement over the prior art of clustering of items into hierarchical classifications, we utilize Expertise, Regard, Quality and Caliber, and related methods, to focus the analysis on contributions of more highly regarded users and, generally, on higher quality items. Thus, as ratings enter the system (along with additional user-contributed items), we construct more robust hierarchies of classification, and increase the accuracy of automated means of placing items within them.

We improve search technology in the prior art, using Expertise, Regard, Quality and Caliber, and related methods, to differentiate among search results derived by concept clustering methods of information retrieval, and also to provide additional granularity in pairwise comparison methods. We provide procedures for explicitly trading off relevancy and quality, and methods of efficiently blending multiple criteria for large data sets.

An embodiment of the invention described herein collects at a single network node (or in a distributed environment) user contributions spanning multiple categories of content, while minimizing the need for users to categorize each of their contributions and reducing the navigation required to locate content in an area of interest—all enhanced with robust, quality control technologies.

Advantages of the described embodiments will be set forth in part in the description that follows and in part will be obvious from the description, or may be learned by practice of the described embodiments. The objects and advantages of the described embodiments will be realized and attained by means of the elements and combinations particularly pointed out in the appended claims and equivalents.

### DESCRIPTION OF DRAWINGS

FIG. 1 displays a threaded discussion.

FIG. 2 demonstrates the use of a filtering method.

FIG. 3 lists Usenet newsgroups selected for combination In an “Autos” category.

FIG. 4 is a binary tree representation of a cluster model generated by automated means.

FIG. 5 is an excerpt of a mapping of threads to nodes in a cluster hierarchy.

FIG. 6 displays a series of computer file directories representing a binary tree structure

FIG. 7 presents key words derived from a cluster model of “Autos” category content.

FIG. 8 demonstrates a selective subclustering of a binary tree cluster model

FIG. 9 presents key words derived from a selective subclustering of a binary tree cluster model of “autos” category content.

FIG. 10 is an example of cluster classification probabilities derived for a new, unclassified item or query.

FIG. 11 diagrams the submission of search terms by a user, leading to search and retrieval of items and subsequent user interaction.

FIG. 12 illustrates the use of cluster classification as a single criterion for identifying matching items in a search engine context.

FIG. 13 the interpretation of a user rating using methods to determine ratings of items, groupings of items and authors/contributors of items.

FIG. 14 sets forth steps in the incorporation of a new item of content.

FIG. 15 diagrams a successive approximation procedure to determine ratings of items, groupings of items and authors/contributors of items.

FIG. 16 presents an overall picture of circular operations.

FIG. 17 illustrates the utility of a secondary criterion for matching items in a search engine context.

FIG. 18 depicts (in the form of a graphical user interface) a search engine result based upon dual criteria.

FIG. 19 depicts (in the form of a graphical user interface) a search engine result based upon cluster classification, ratings of authors and item quality, and pairwise relevancy as a multiple criteria.

FIG. 20 sets forth possible query results in matrix form, a layout referred to herein as “pixelization”.

FIG. 21 is a flowchart of an embodiment of a pixel traversal method.

FIG. 22 illustrates a method of efficient traversal of pixelized search results.

FIGS. 23-26 set forth a wide area network and a series of network nodes, servers and databases, and a number of information transactions in a preferred embodiment of the Invention.

### DETAILED DESCRIPTION OF THE PREFERRED EMBODIMENTS

### 1. Threads/Outlines

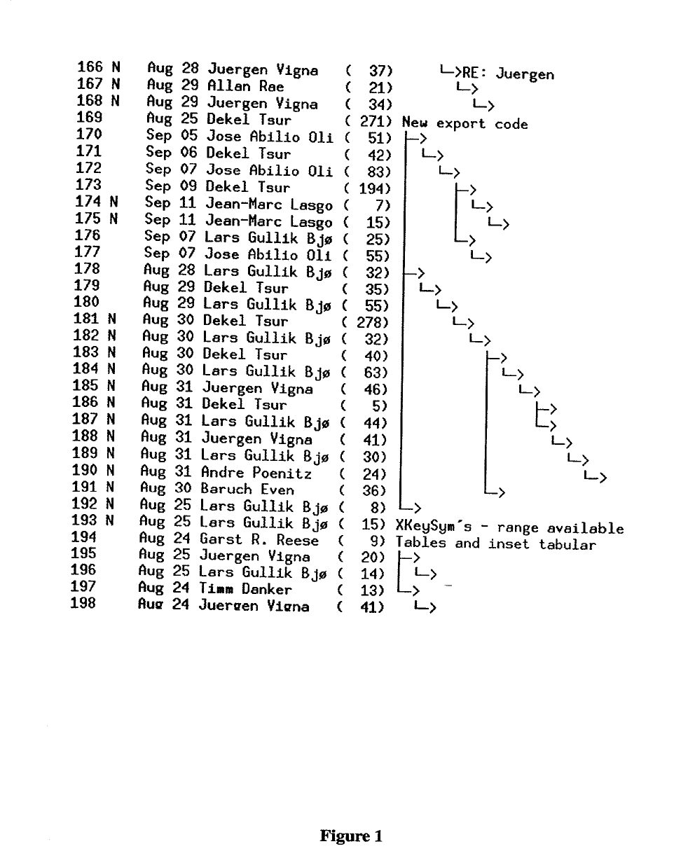

In preferred embodiments, the invention is applied to threads—a series of interrelated messages, articles or other items, each either initiating a new thread or responding to an existing thread, as depicted in FIG. 1. Examples of threads include Usenet newsgroups, “listserve” mailing lists, online forums, groupware applications, customer service correspondence, and question and answer dialogs.

In certain related embodiments, the invention is applied to content expressed in an outline format, or otherwise embodying a structure that can be expressed or reduced to an outline, which includes items associated with particular user-contributors. An example of an outline is a corporate knowledge base constructed by multiple contributors to service an internal constituency (e.g. employees) or an external constituency (e.g., customers or suppliers).⁶ ⁶ By the adoption of a defined format for entering information in an outline structure, with limitations on the number of outline levels and the generality of major headings, an outline structure can be reduced to a thread structure, and the methods specified below directly applied.

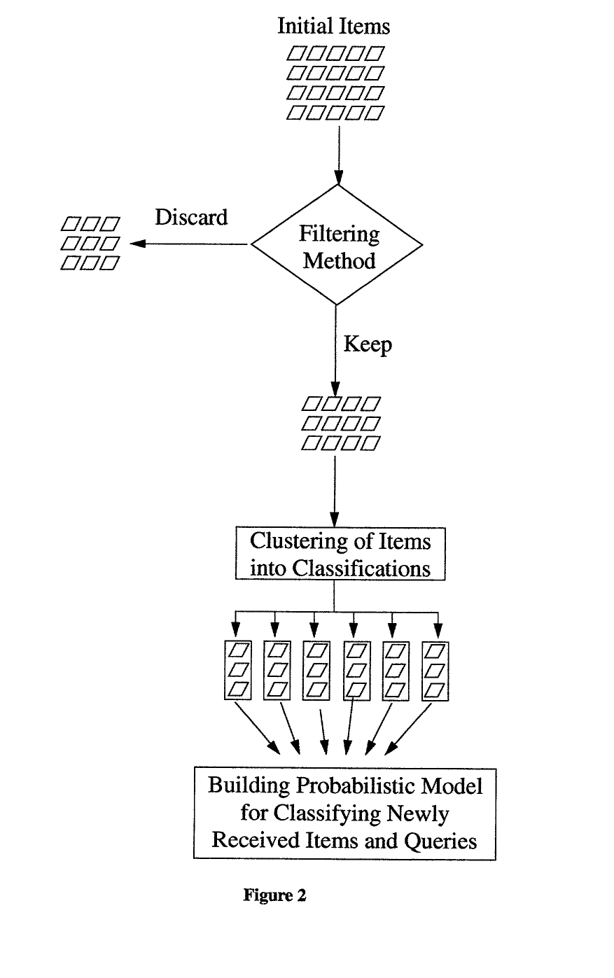

FIG. 2 is a flowchart that sets forth the use of a filtering method (at the point of inserting items) to reduce the volume of content used to build database search and retrieval facilities, from an initial collection to a subset based on standards that improve the data set for clustering and classification, as set forth below.

Let A^{aid} represent the contents of a message, article or other item, with aid denoting an “article ID” for identification in a database. Let T^{tid} represent the contents of a thread, with tid denoting a “thread ID”.

1.1. Basic Filtering. The filtered, aggregated content of a thread can be represented as

$${T}_{f}^{tid} = {\sum }_{aid ε tid} f ( {A}^{aid} )$$

where f(.) represents a filtering algorithm that eliminates contents deemed irrelevant to indexing and clustering analysis (e.g., RFC 822 headers, “stoplisted” word, punctuation, word stems), and denotes the concatenation of the remaining text.

1.2. Enhanced Filtering. Expertise, Regard, Quality, Caliber, and related methods can enhance the construction of thread (or article) databases relevant to cluster analysis.

The filtered, aggregated content of a thread can be represented as

$${T}_{f , \overline{h} , \overline{q}}^{tid} = \{ \begin{matrix}{\sum }_{aid ε tid} f ( {A}^{aid} ) & if h [ uid ( aid ) ] > \overline{h} or q ( aid ) > \overline{q} \\ null & otherwise\end{matrix} \qquad ( 1.1 )$$

where uid (aid) is the user ID of the user associated with article aid, h(uid) is either Expertise or Regard, as the case may be, of such user, //h is a selected threshold value, q(aid) is the Quality of article aid, and q is another selected threshold value.⁷ ⁷ In this example embodiment, articles are included in the thread if the author has an Expertise or Regard, as the case may be, greater than the specified threshold Expertise or Regard, or the article has a Quality value greater than the specified threshold Quality (an embodiment of the Caliber method). Additional embodiments reflect the use of one or more Expertise, Regard, Quality or Caliber methods, and tradeoffs between derived values, to limit the inputs into cluster analysis. Additional embodiments take one of more Expertise, Regard, Quality or Caliber methods as an additional input into cluster analysis, affecting the weight of each item in calculations of document “proximity”.

Herein,

$$T \frac{tid}{f}$$

can represent, for example, filtering based on the Basic or Extended methods of Expertise or High Regard, and

$$A \frac{aid}{f}$$

the application of such methods at the article, rather than the thread, level.

### 2. Concept Clustering

2.1. Introduction. Document indexing technologies in common use today are capable of “clustering” items contained in large content databases into groupings based on common concepts.

Within the confines of the prior art, concept clustering is generally considered to have limited application to traditional threaded discussions. Given the historical practice of narrowly defining forum subject matter, often postings with common concepts are already grouped together—in large part, by the participants themselves.

Still, the pre-classification of forum subject matter is limiting, sometimes arbitrary, and inflexible over time, and places additional burdens on users.

Concept clustering has the potential to reduce the use, or at least the specificity, of prefabricated limitations on forum content. Instead, a user might specify a concept (or search terms from which concepts may be identified) and be served up forum postings with the same or related concepts, according to a recent and comprehensive automated analysis. Similarly, a user could contribute an article without selecting a narrowly defined forum and, again based on an automated analysis of conceptual content, the posting could be automatically positioned alongside related content for future users.

2.2. Methods. In typical techniques of concept clustering, terms contained in each item are “tokenized”, or given reduced form expression, and mapped into so-called “multidimensional word space”. A model is constructed that effectively evaluates each item for its “proximity” to other items using one of a variety of algorithms. Clusters of items are considered to reflect common concepts, and are therefore classified together.

Methods of scoring document relationships include Naive Bayes, Fienberg-classify, HEM-classify, HEM-cluster and Multiclass. The “crossbow” application in the libbow package offers an implementation of these methods.

To keep such a model current, clustering is conducted periodically. The resulting classification scheme can organize content received incrementally and serve as a basis for responding to certain kinds of search queries.

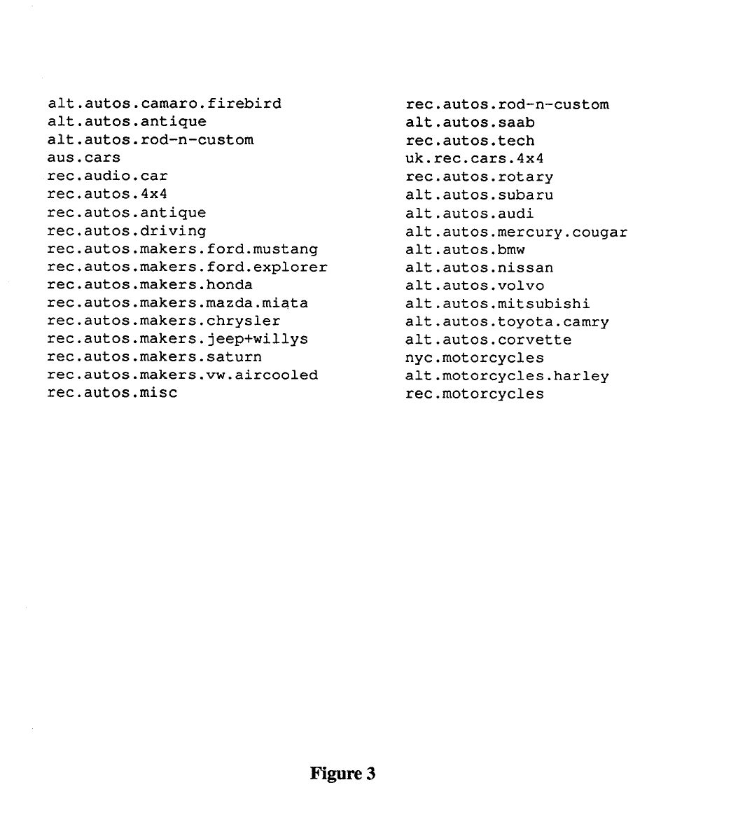

2.3. Binary Tree Representation. As an illustration, we collected 147,410 articles from 34 Usenet newsgroups related to automobiles, set forth in FIG. 3 (agglomerating all the forums), assembling 26,053 threads by applying a filtering method as set forth in Section 1.1, and using automated means to classify the threads into concept clusters.

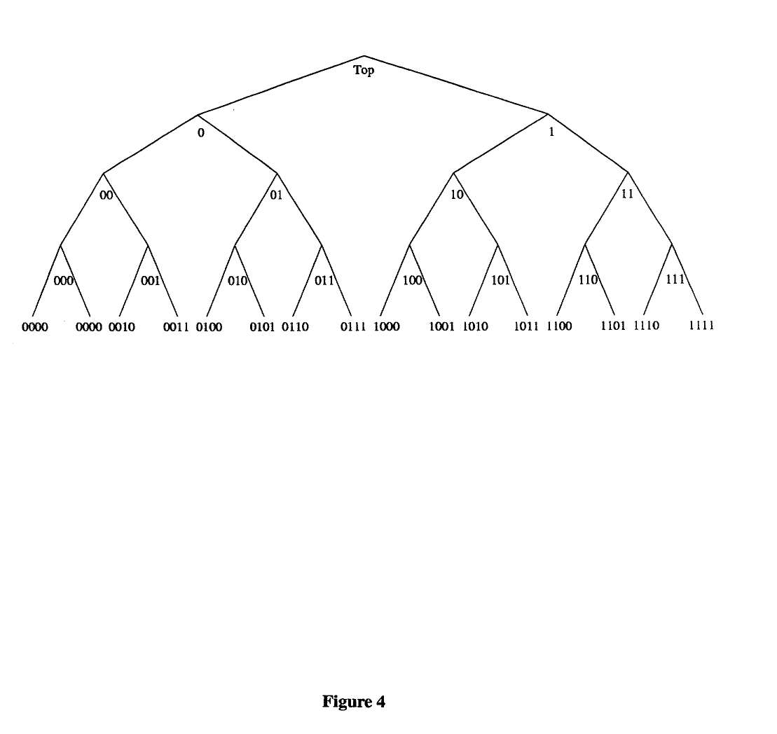

Using crossbow, selecting the method of Naive Bayes, we conducted a limited clustering procedure yielding a four-level binary tree division into 16 cluster leafnodes, represented by FIG. 4.

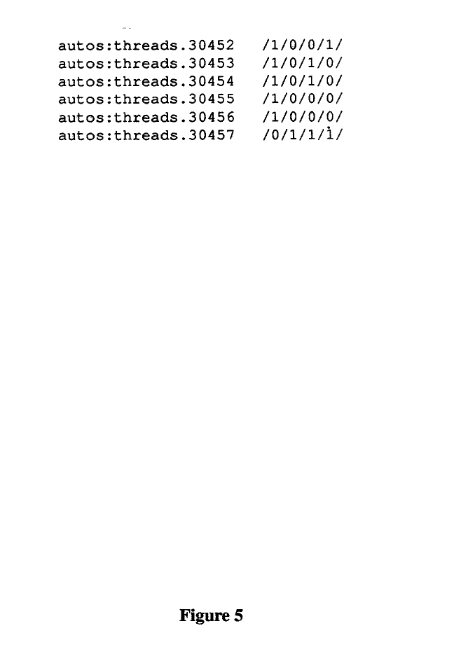

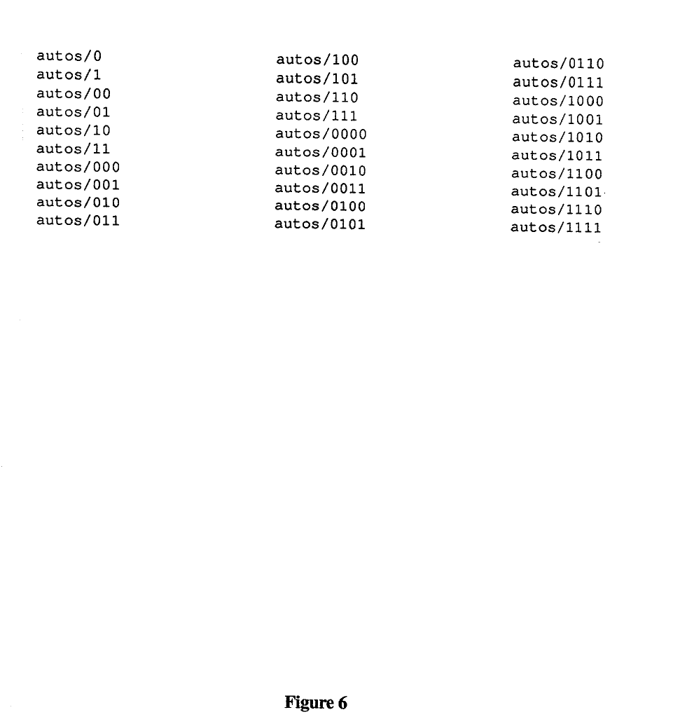

2.4. Populating the Tree. Crossbow outputs an assignment of each thread to nodes at each level of the binary tree (as excerpted in FIG. 5). We created a hard disk drive representation of the binary tree, with a directory representing each node (as forth in FIG. 6) and placed therein symbolic links to each

$$T \frac{tid}{f}$$

for further analysis.

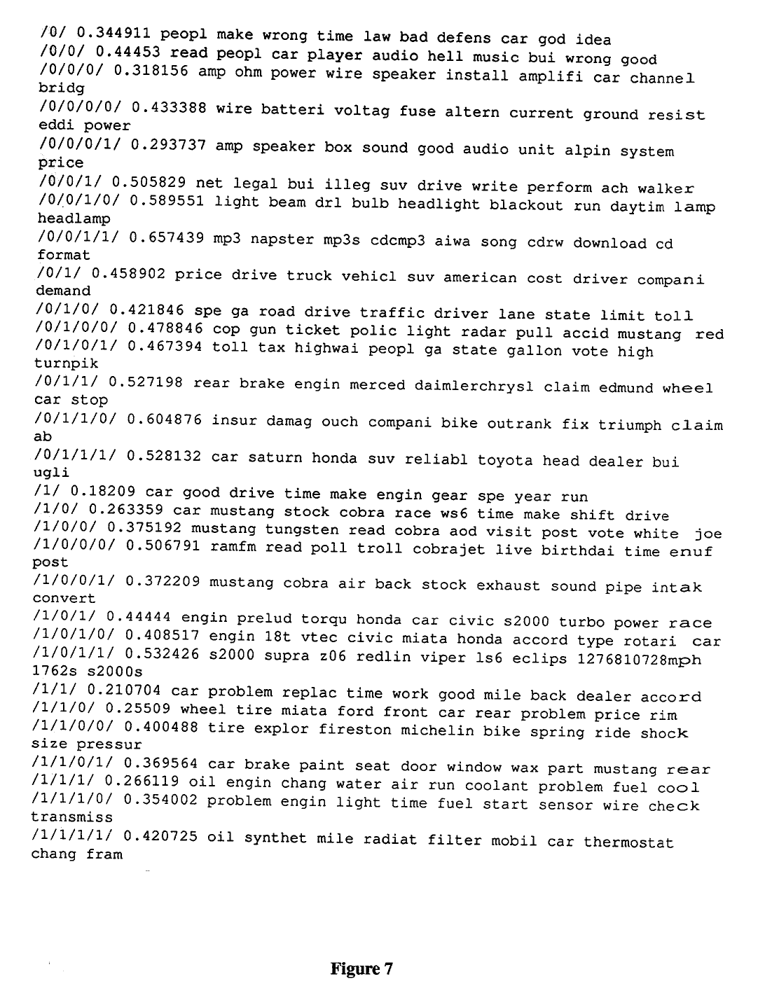

Keywords deemed by crossbow the most relevant to each node in the tree are set forth in FIG. 7.⁸ ⁸ Filtering applied the Porter stemming algorithm (included in libbow), stripping words of obvious stems.

2.5. Extensions of the Binary Tree. It is possible to cluster the tree deeper than four binary levels, achieving additional granularity in the results, with each level multiplying by two the number of total concept clusters at the leafnodes.⁹ ⁹ It is also possible to apply all these methods to tree structures that fork in three or more directions, rather than the binary structure we focus upon here.

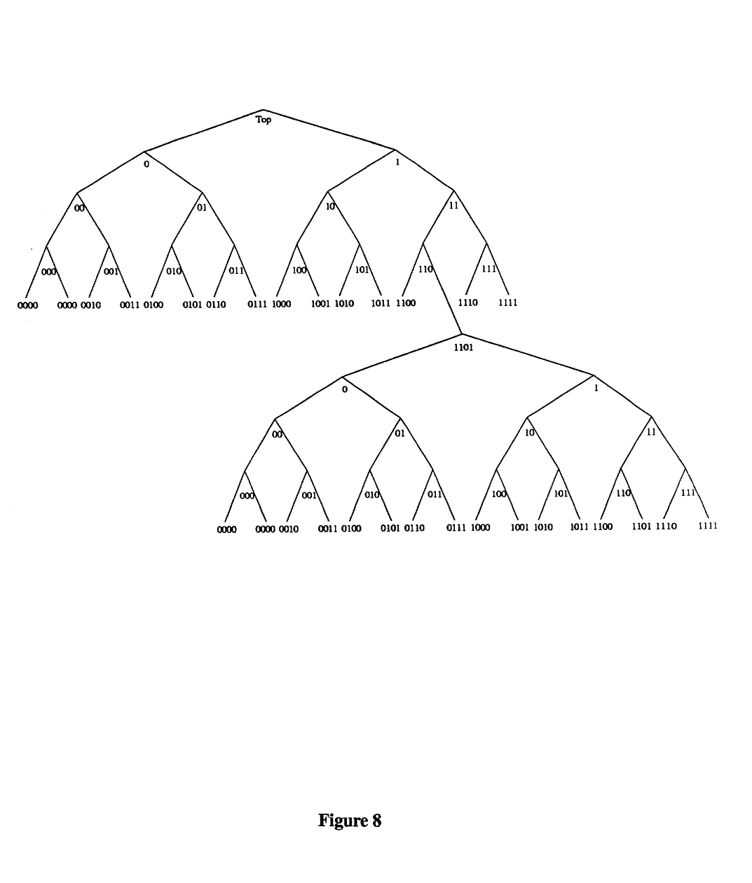

Alternatively, for a more selective targeted approach, it is possible to “subcluster” portions of the binary tree based on the number of articles in particular clusters, or judgments about the potential for a rich set of concepts to be found, or other factors. The subclustering of a single cluster is represented in FIG. 8.

We created a hard disk drive representation of the subcluster, with a directory representing each node and placed therein symbolic links to each

$$T \frac{tid}{f}$$

for further analysis.

Crossbow outputs the information necessary to assign each article to one of the nodes at each level of the extended binary tree, from the top level to the leafnodes. We created a hard disk drive representation of the extended binary tree with a directory representing each node. It was then possible to locate therein copies (or symbolic links) of each

$$T \frac{tid}{f}$$

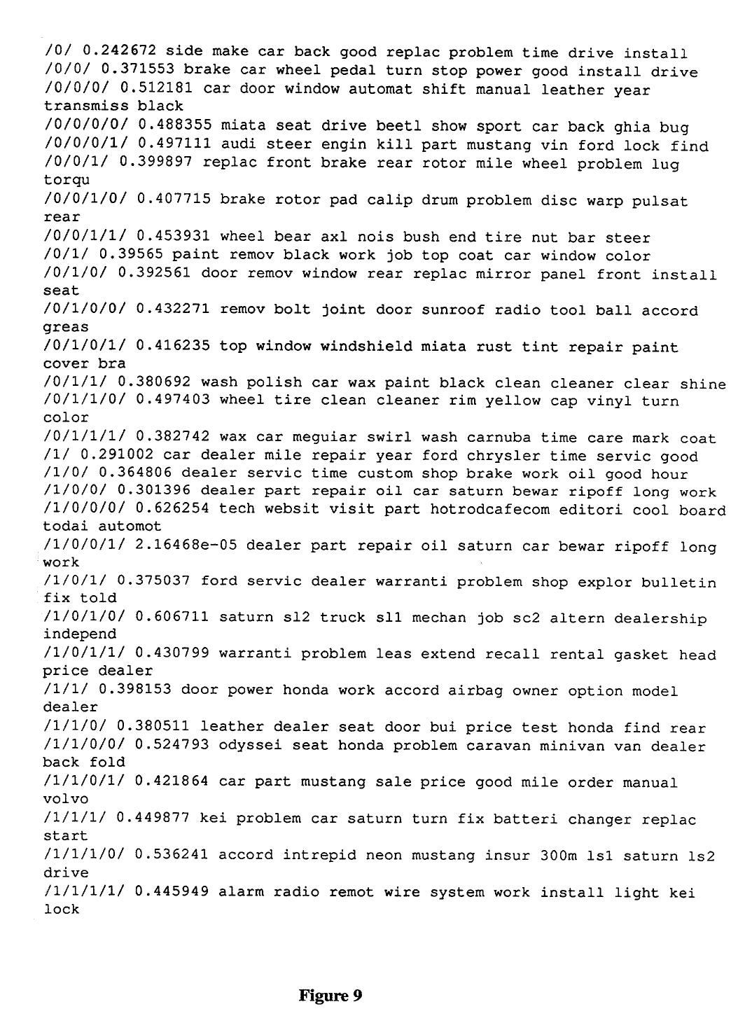

for further analysis. Keywords deemed by crossbow the most relevant to each node in the tree are set forth in FIG. 9.

The identifier used here for a position in the binary tree is a concatenation of the nodes in all the preceding levels. For example, the right most, lowest level node in the subclustered portion of this extended tree is 11011111.

This procedure can be iterated still a further step, subclustering a subcluster, etc.

### 3. Cluster Classification and Additional Criteria

3.1. Probabilistic Cluster Classification. With such a hard disk drive representation of the binary tree, it is possible to analyze and classify a new article or a user-provided query.

Any of a number of algorithms, such as Active, Dirk, EM, Emsimple, KL, KNN, Maxent, Naive Bayes, NB Shrinkage, NB Simple, Prind, tf-idf (words), tf-idf [log(words)], tf-idf [log(occur)], tf-idf and SVM, may be used to generate a database and model for analyzing new items, in order to determine the probability associated with every fork traversing the tree from top to bottom. Rainbow in the libbow package offers an implementation of these methods.

Crossbow includes additional, more efficient methods of classification, in particular implementations of Naive Bayes Shrinkage taking into account the entire binary tree structure.

These models can also derives probabilistic classifications of user-provided queries (search terms).

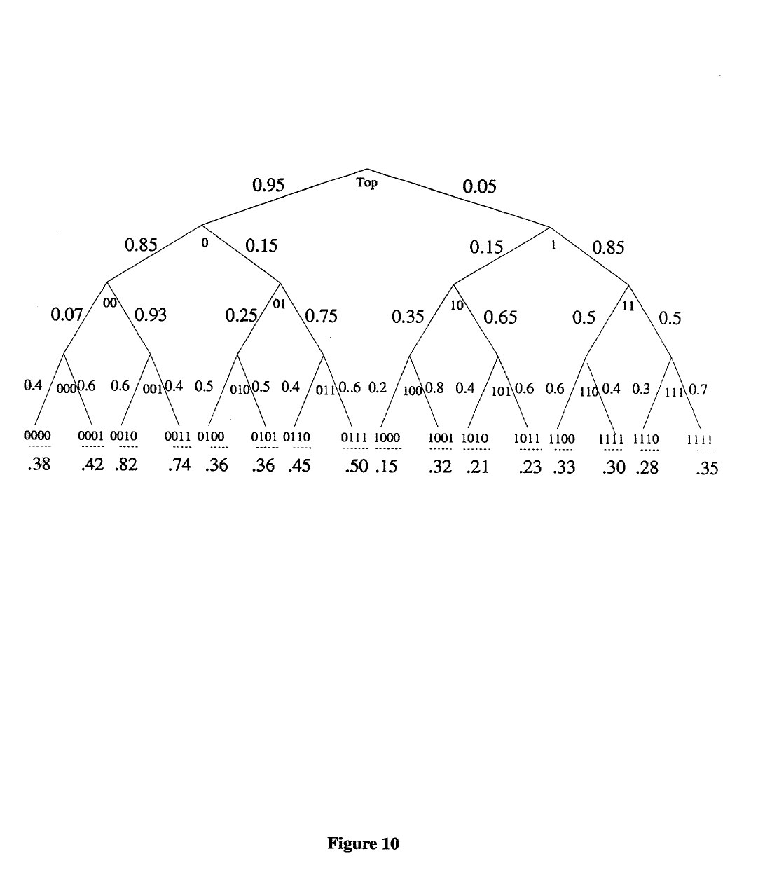

For example, using rainbow we derived a set of forking probabilities for a newly received item, set forth in FIG. 10. In the case presented, there is a 0.95 probability that the item is best associated with cluster 0 rather than cluster 1; a 0.85 probability it is best associated with cluster 00 rather than cluster 01, a 0.07 probability it is best associated with cluster 000 rather than cluster 001; and a 0.4 probability that it is best associated with cluster 0000 rather than cluster 0001.

The cumulative probability associated with each of the leafnodes is

$${P}_{leafnode} = levels \sqrt{{\prod }_{top}^{leafnode} {p}^{node}}$$

For example, the cumulative probability associated with leafnode cluster 0000 is

P₀₀₀₀=4\sqrt{0.95×0.85×0.07×0.4=0.38}

Such databases can be regenerated periodically to include incrementally received items and apply updated inputs into the selected filter model, including revised values of Expertise, Regard, Quality and Caliber, to keep the model current, increase selectivity and improve accuracy.

3.2. Single Criteria Query. Given a user-provided query (search terms), a cluster-oriented search engine can identify groupings of items already in the system, e.g., clusters of related threads of discussion, containing conceptually similar material.

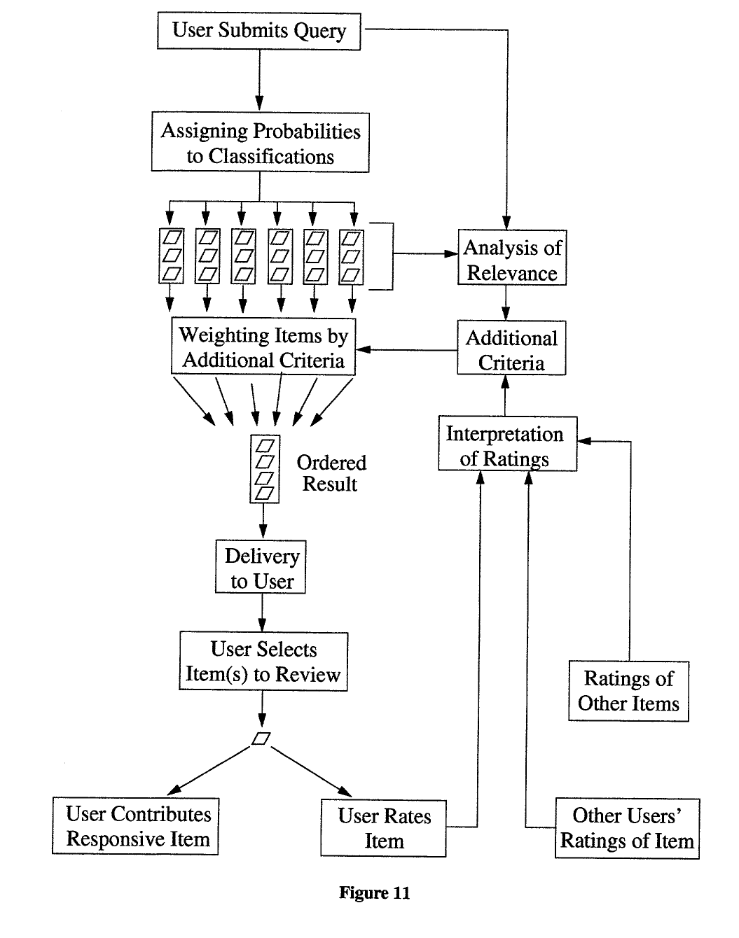

FIG. 11 is a flowchart of submission of a query by a user, leading to search and retrieval of items, delivery of the items to the user, and subsequent user interaction with the items. The query is analyzed in the same manner as a new item that survives filtration. However, instead of simply determining the most likely appropriate classification for the query, the specific probabilities associated with each alternative classification are noted for further analysis in methods of search and retrieval. The determination of an ordered result for delivery of items to the user may include consideration of classification probabilities as a single criteria, or the application of additional criteria in tandem.

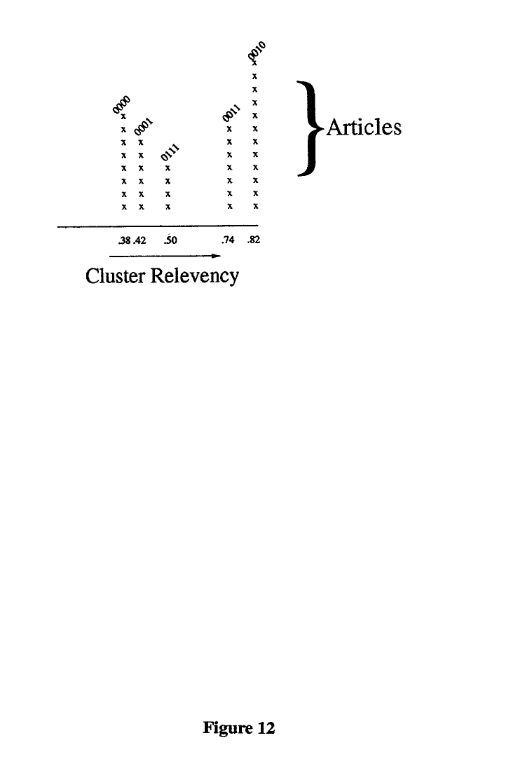

Using the binary tree and probabilities depicted in FIG. 10 as an example of possible classifications of a user-provided query, the top five clusters could be scored along an axis measuring cluster relevancy, as in FIG. 12.

Without additional criteria, the score of each thread contained in a cluster is the same, based exclusively on the concept proximity between the cluster and the query, i.e., the cluster probability derived by rainbow or crossbow. ¹⁰

Score_{tid}^{query}=P_{cluster}_{^{tid}}^{query}

Where P_{cluster}_{^{tid}}^{query} is the probability that the query should be classified as a member of the cluster that contains thread tid. This is a measure of the conceptual proximity of the thread to the query, i.e., how well the thread matches the query. ¹⁰ In applications that focus on scoring articles, the cluster identification of an article might simply be mapped to the cluster identification of the thread that contains it. So that

score_{aidεtid}^{query}=P_{cluster}_{^{tid}}^{query}

As the foundation of search engine for matching threads, this approach would return all the threads in cluster 0010, followed by all the threads in cluster 0011, followed by all the threads in cluster 0111, and so on.

There is no criteria to distinguish among the threads in any particular cluster. For example, the search would return the lowest quality items in cluster 0010 before returning the highest quality items in cluster_0011. Also, there is no accounting for the magnitude of the differences in cumulative cluster probability. For example the relative proximity of cluster 0010 and cluster 0011 at the high end, and the relative distance between cluster 0011 and next cluster 0111, have no impact on the analysis.

The size of the first document cluster in such a list may be so large that users rarely move beyond it to other relevant material.¹¹ In a case such as depicted here, in which two clusters are scored near the high-end of the observed range (i.e., cluster 0010 has a cumulative probability of 0.82, and cluster 0011 has a cumulative probability of 0.74), highly relevant material in the second cluster might be neglected. ¹¹ Sorting by date, with date span cut-offs, might make this type of review more practical.

3.3. Derivation of Additional Criteria. Among the derivatives of the framework set forth here as preferred embodiments are methods of rating authors, the quality of articles, and relationships between individual articles (relevancy).

As set forth in FIG. 11, in certain embodiments a user to whom items are delivered in an ordered search result may select certain items for review, rate some items and contribute responsive items, e.g., a response to an article in a threaded discussion. Each form of user interaction contributes information that may be interpreted, serving as the basis for additional criteria which facilitate more robust ordering of results for fixture searches.

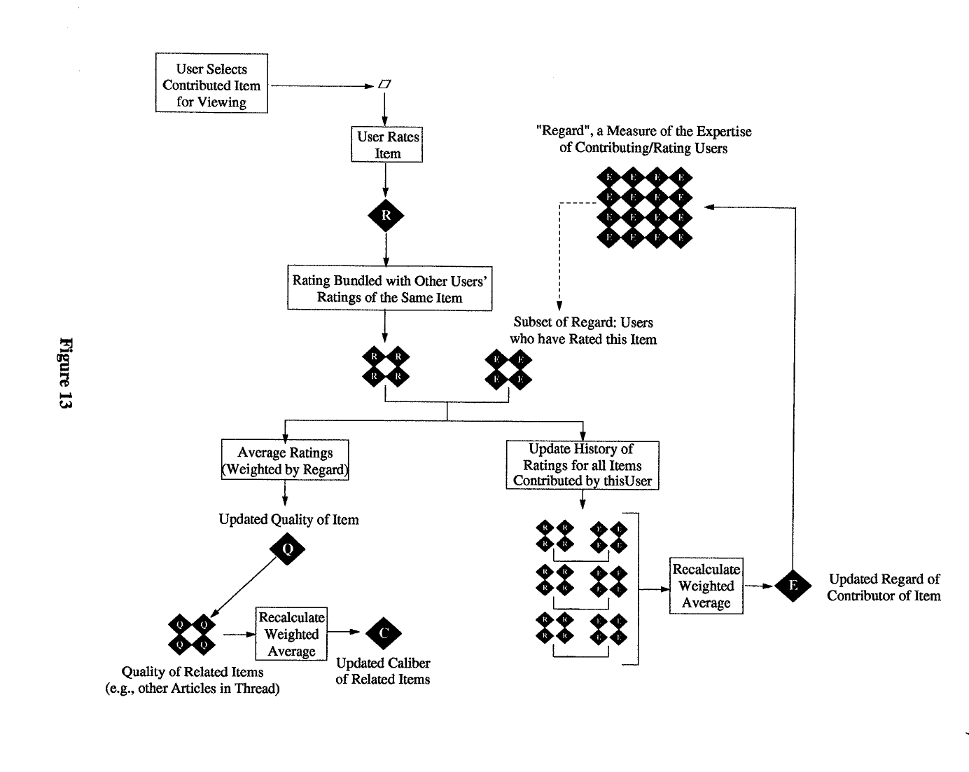

For example, FIG. 13 is a flowchart of several steps in the interpretation of a user rating of an item in certain embodiments, using methods of calculating Expertise, Regard, Quality and Caliber incorporated herein by reference.

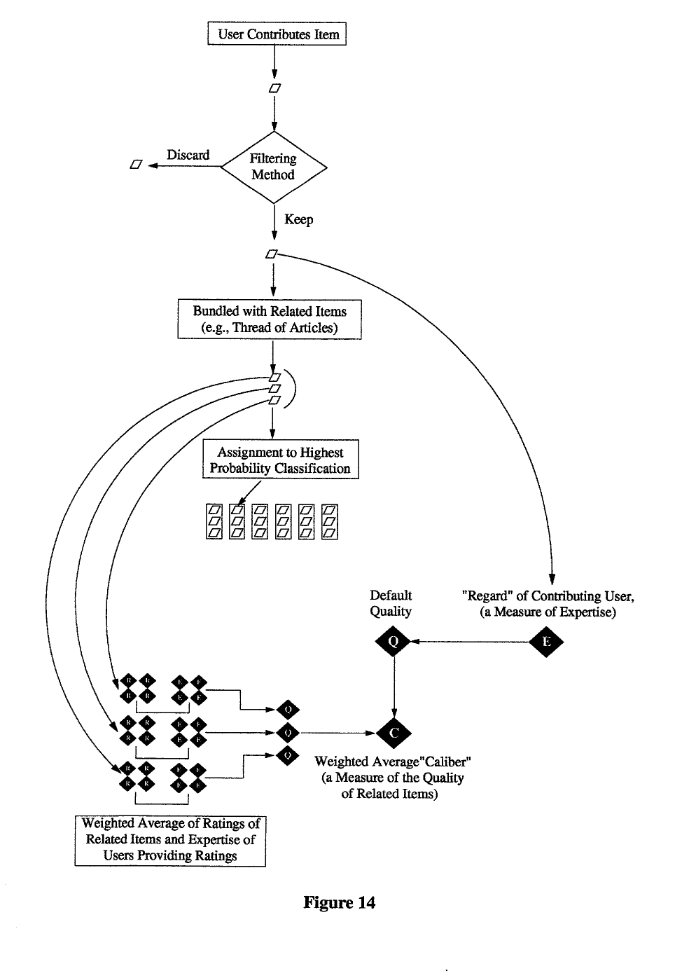

FIG. 14 is a flowchart of steps involved in certain embodiments in the incorporation of a newly contributed item. If the item, e.g., an article, is identified as a member of an existing thread, it is bundled with the other member of the thread for calculation of Caliber, a measure of thread quality, and if a Regard value is available, it is established as a default measurement of the Quality of the item.

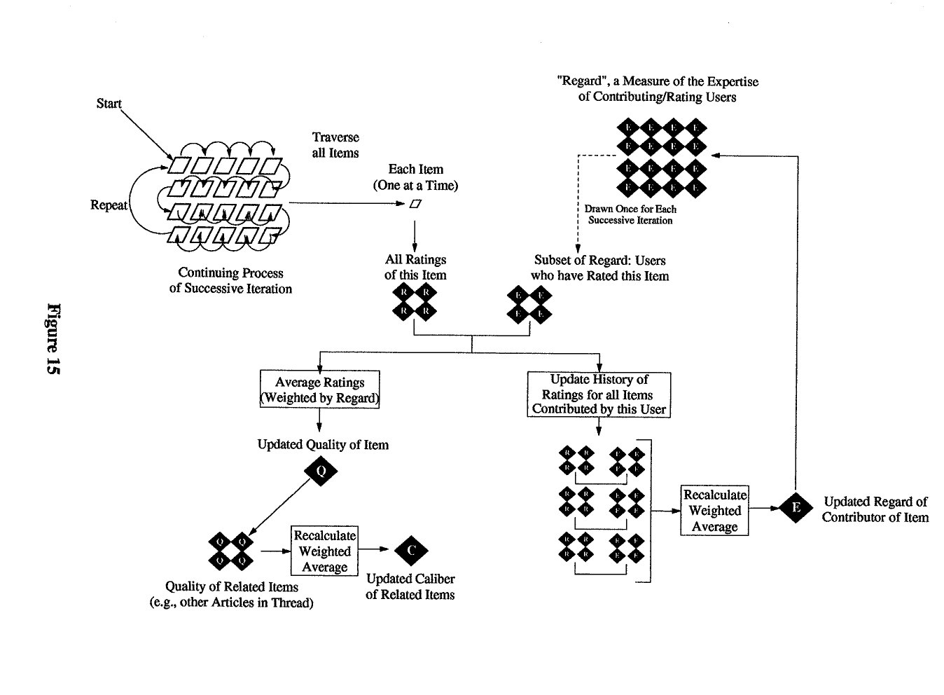

FIG. 15 is a flowchart of iterative steps of successive approximation of Regard, in embodiments using High Regard methods for rating articles and deriving Regard, Quality and Caliber. In alternative embodiments, these iterative methods are conducted periodically or in real-time, upon the receipt of new ratings.

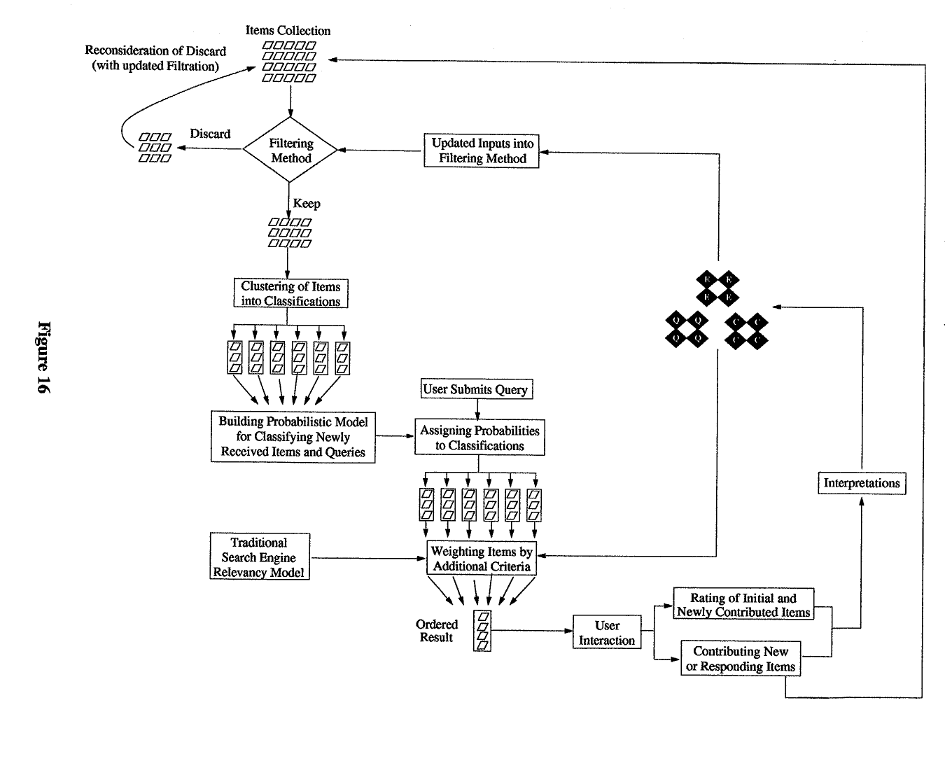

FIG. 16 presents an overall picture of the circular nature of the process, in terms of the manner in which filtration improves the input into clustering/search models and methodology, which makes methods of search and retrieval more accurate, which helps users identify content for review, rating and response, which generates more content and makes ratings more robust and accurate, which in turn improves the inputs into the process.

Another use of initial data and improved inputs is traditional search engine relevancy modeling, based on pairwise comparison of items using standards such as common words or word usage/frequency, or common concepts or concept usage/frequency.

3.4. Blended Scoring with Secondary Criteria. With a secondary criteria for evaluating content, it is possible to return a more precisely ordered search result using a blended method to score threads:

score_{tid}^{query}=b[P_{cluster}_{^{tid}}^{query}, α(query, tid)]

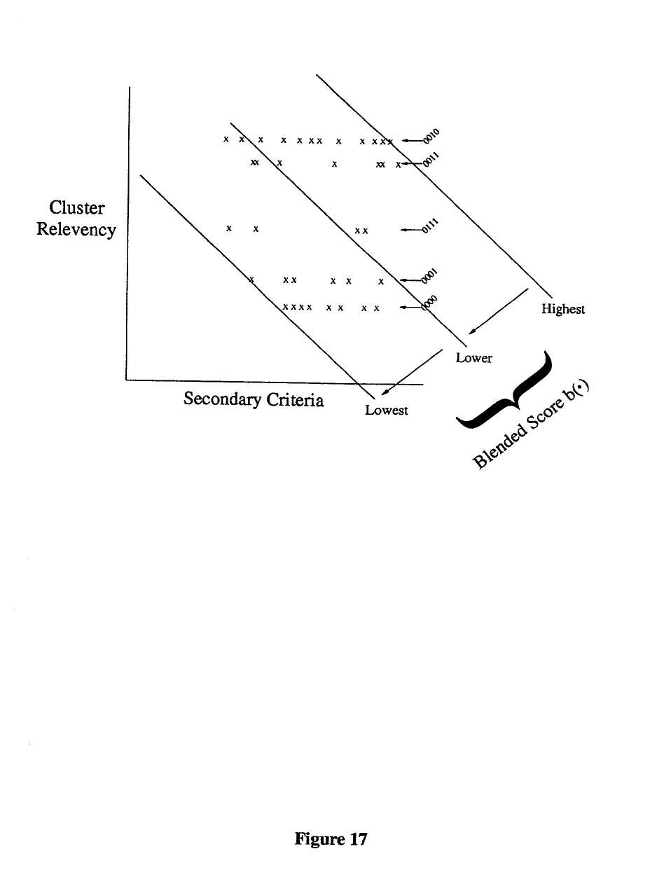

such that the “best” of cluster 0010 and the “best” of cluster 0011, under the secondary scoring method represented by α(.), are near the top of the list, and the “worst” of cluster 0010 is presented somewhat later, as depicted in FIG. 17. Note that, in this example, the “best” of cluster 0000 would be presented after the “worst” of cluster 0010 or 0011, because of a lower blended score.

Required here is a defined trade-off between the cluster relevancy and the secondary criterion to blend the two scoring methods, represented by b(.), which is depicted in FIG. 17 as a series of parallel diagonal lines (represented a weighted average) with the highest blended score along the upper right diagonal line.¹² ¹² The trade off represented by b(.) might be non-linear, rather than a straight line relationship. Additional variables or factors could be introduced, with the blended scoring method represented by a plane in three dimensional space or with higher-order dimensional representations.

3.5. Potential Secondary Criteria.

Author Rating. α(.)may represent a thread ranking based on a method β(.) of rating the authors of all the articles contained in the thread:

α(T_{f}^{tid})=β[uid(aid)|_{aid}^{aidεtid}]

Examples of author ratings include:

An objective benchmark such as the length or volume of the author's participation.

A simple mathematical average of user-provided ratings of authors, based on a single rating by each user of another user, or a rating on a per-article basis or another basis.

The Expertise or Regard of the author.

Hence, blended scoring based on cluster relevancy and author ratings might be expressed as

score_{tid}^{query}=b {P_{cluster}_{^{tid}}^{query}β[uid(aid)|_{aid}^{aidεtid}]

Article Ratings. α(.) may represent a thread ranking based on a method γ(.) of rating all the articles in the thread:

α(T_{f}^{tid})=γ[uid(aid)|_{aid}^{aidεtid}]

Examples might include:

An objective benchmark, such as the length of the article, or the number of times it has been read, or responded to, by users.

A simple mathematical average of user-provided ratings of articles.

The Quality of the article.

Hence, blended scoring based on cluster relevancy and article ratings might be expressed as

score_{tid}^{query}=b {P_{cluster}_{^{tid}}^{query}γ[(aid)|_{aid}^{aidεtid}]

Thread Ratings. α(.) may represent a direct ranking of thread Ttid/f. Examples might include:

An objective benchmark, such as the length of the thread, or the number of times it has been read, or responded to, by users.

A simple mathematical average of user-provided ratings of threads.

The Caliber of the thread. In effect, Caliber is an embodiment combining the concepts of author and article ratings

α(T_{f}^{tid})=δ{β[uid(aid)|_{aid}^{aidεtid}, γ|_{aid}^{aidεtid}]}

wherein δ(.) represents the Caliber calculation, β(.) author Expertise or Regard, as the case may be, and γ(.) article Quality.

Hence, scoring based on cluster relevancy and thread ratings (in the form of Caliber) might be expressed as

score_{tid}^{query}=b(P_{cluster}_{^{tid}}^{query}, δ{β[uid(aid)|_{aid}^{aidεtid},γ|_{aid}^{aidεtid}]})

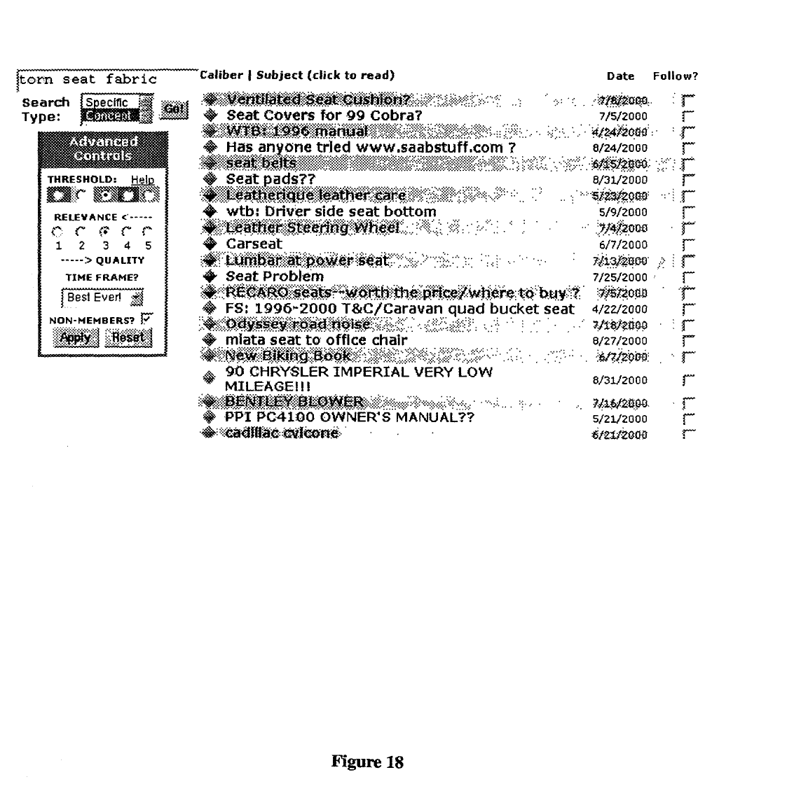

FIG. 18 presents the use of this technique to query our autos database. In this example, b(.) represents a blending of cluster relevancy and Caliber through the use of a weighted arithmetic average. The user is permitted to select alternative weights to determine the blending between “RELEVANCY vs. QUALITY” (i.e. cluster relevancy vs. Caliber)—in this case, selecting either (0.00, 1.00) or (0.25, 0.75) OR (0.50, 0.50) OR (0.75, 0.25) or (1.00, 0.00) by selecting 1, 2, 3, 4 or 5, respectively, in the depicted user interface box.

The query result moves from “green diamond” rated items (representing Caliber of 0.875 to 1.0)¹³ to “blue diamond” rated items (representing Caliber of 0.625 to 0.875)¹⁴ in the most relevant cluster, and back to “green diamond” rated items in a less relevant cluster.¹⁵ ¹³ The first six search results in this example, from “Ventilated Seat Cushionh?” to “Seat pads??”. ¹⁴ The next seven search results, from “Leatherique leather care” to “RECARO seats—worth the price/where to buy?”. ¹⁵ The next eight search results, from “FS: 1996-2000 T&C/Caravan quad bucket seat” to “cadillac cylcone”.

In other words, based on blended formula, content in the highest Caliber range, but in a cluster of secondary relevancy, will be positioned in the sorted response list prior to content in the most relevant cluster that is considered lower Caliber (i.e., “gray diamond”, “yellow diamond” or “red diamond” rated, each representing Caliber segments below 0.625).

Search Term Relevancy. α(.) may represent a pairwise analysis of relevancy, a procedure distinctive from the analysis of cluster relevancy.

Focusing on articles rather than threads for this example, pairwise analysis of relevancy, including term overlap, term frequency within a document, term frequency among documents and other factors, may be represented as

$$α ( query , {A}_{f}^{aid} ) = ε ( query , {A}_{f}^{aid} \vert \begin{matrix}{A}_{f}^{n} \\ {A}_{f}^{o}\end{matrix} )$$

where

$${A}_{f}^{aid} \vert \begin{matrix}{A}_{f}^{n} \\ {A}_{f}^{o}\end{matrix}$$

represents all the filtered articles in the system, which will have been pre-processed and “tokenized” to a reduced form representation for efficient pairwise comparison. An implementation of pairwise methods, and related methods, may be found in the archer package of libbow.

Blended Scoring with Tertiary Criterion. With the addition of a third criterion for evaluating content in a blended method, it would be possible to user-specified query (search terms) and return an even more precisely ordered result.

For example, one might combine the methods of concept clustering, article Caliber¹⁶ and search term relevancy, as a method of scoring articles and threads

$${score}_{tid}^{query} = max ( {score}_{aid}^{query} = θ [ {P}_{{cluster}^{tid}}^{query} , δ \{ β [ uid ( aid ) {\vert}_{aid}^{aid ε tid} , {γ [ aid \vert}_{aid}^{aid ε tid} ] \} ε ( query , {A}_{f}^{aid} {\vert}_{{A}_{f}^{o}}^{{A}_{f}^{n}} ) ] )$$

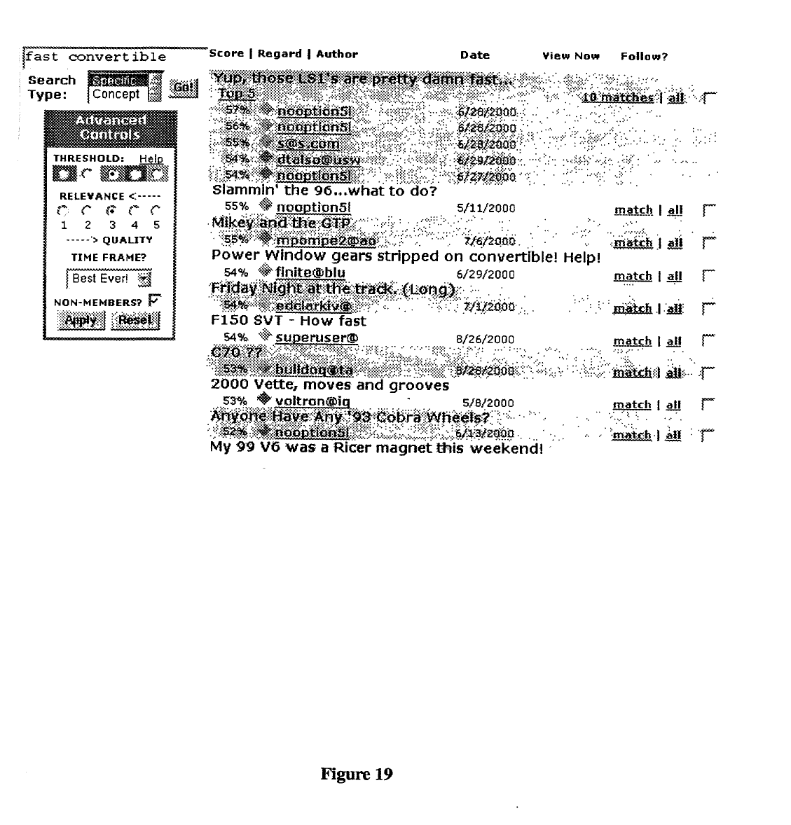

FIG. 19 presents the use of this technique to query our autos database. In this example, θ represents a blending of cluster relevancy, Caliber and search term relevancy through the use of a weighted arithmetic average. The user is again permitted to select alternative weights for “RELEVANCY vs. QUALITY” (i.e., cluster relevancy on the one hand, and Caliber or Quality on the other). The result is then applied to weight the search term relevancy calculation. ¹⁶ Varying from the previously referenced formulation of Caliber in the thread context, article Caliber is this instance is a function of the Regard of the author of the article and the Quality of the article; for example, Caliber could be the higher of the two values, subject to thresholding.

### 4. Pixelized Secondary Criteria

4.1. The Computational Challenge of Blended Criteria. A secondary criterion may be both inclusive and exclusive, in that a small part of the data set is identified as a possible search result and a large part of the data set is ruled out. For example, search term relevancy as described in Section 3.5 reduces the possible responses to items with a high degree of term overlap, so that only a small number of “blending” calculations need be done, significantly reducing computational requirements.¹⁷ ¹⁷ This is also true if a tertiary or additional criterion is inclusive and exclusive in this sense. For example, the search term relevancy measure utilized as a tertiary criterion in Section 3.5 reduces the possible responses to articles with term overlap, which are the only items for which the full blended calculation need be conducted.

By contrast, note that the secondary criteria of author ratings, article ratings and thread ratings described in Section 3.5 are relative and do nothing to include certain items and wholly exclude others. Instead, they assign a value to every item, each of which is a potential input into a blending calculation.

Without a short-cut procedure, the blended value of every item in the data set would potentially have to be calculated in order to identify the best query responses-potentially an extraordinary computational task—even if only a handful of search results are to be returned to the user.

4.2. Pixelization. The aforementioned relative secondary criteria, including Expertise, Regard, Quality and Caliber, are bounded by zero and one. It is therefore possible to divide up the possible values into a series of ranges and select midpoints therein. Note that the primary criterion, cluster assignment probabilities, are inherently segmented into classifications.

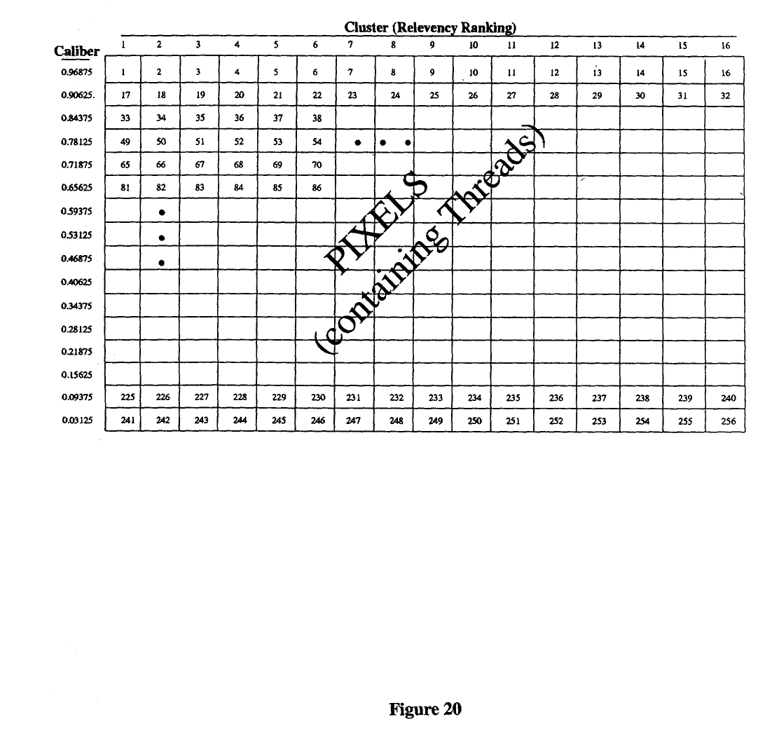

The scope of possible pairs of values, for example, Caliber and cluster assignment probabilities can therefore be expressed as a two dimensional field, segmented into a “pixelized” matrix, into which all of the possible query results will fall, as in FIG. 20.

The cluster relevancy rankings along the top (horizontal) scale represent cluster assignment probabilities, ranked and put into sorted order for a particular query. The Caliber rankings along the left side (vertical) scale represent ranges of possible values of Caliber and their midpoints. Each pixel has been assigned an ID number. Given a basic 16 cluster binary tree and 16 segments of Caliber, as in this example, the pixels are numbered from 1 to 256.

The optimization sought is to compute the full blended score of as few threads as possible—a small multiple of the number of responses intended to be returned to the user, e.g., 3×100—while retaining a high level of accuracy.

The method computes the blended score of the midpoint of certain pixels, identifying a path through the pixels that minimize computational requirements.

Note that whatever blending formula is selected (within reason), pixel #1 will have the highest blended score, and pixel #256, the lowest. So, to begin, the blended score of all the threads in pixel #1 are calculated and the threads are added to our response list.

The next pixel whose contents are to be added to our response list is either the pixel immediately to the right or immediately below, #2 or #17. The choice is based on applying the blending formula to the cluster assignment probabilities and Caliber midpoint values of each pixel. Whichever pixel has the higher score, the blended value of all the threads therein are calculated and the threads are added to the response list.

Which pixel's contents are to be added next? At no time is the next appropriate pixel directly above, directly to the left, or positioned both above and to the left, of the current pixel. We must advance to at least one cluster assignment to the right or one Caliber segment down at each stage. Given a movement of the cluster assignment to the right, it is possible for pixel to be associated with any Caliber segment, so long as the pixel has not already been selected. Given a movement of the Caliber segment down, it is possible for the pixel to be associated with any cluster assignment, so long as the pixel has not already been selected. The two previous sentences are subject to the proviso that at no time is a pixel considered if it is directly below, directly to the right, or positioned both directly below or to the right of any other pixel that meets the criteria for consideration in the same iteration.

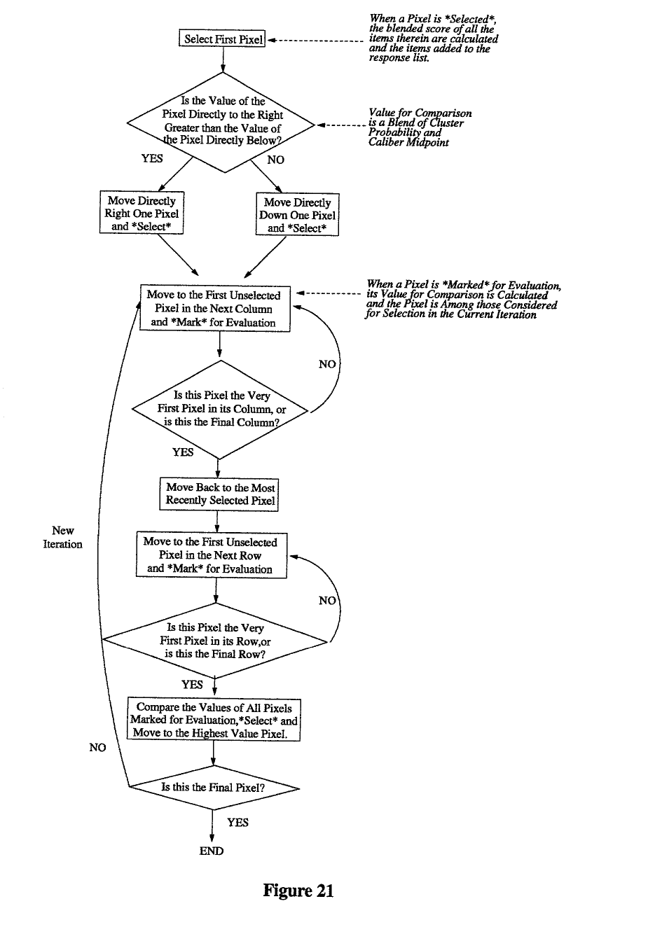

FIG. 21 is a flowchart of an embodiment of a pixel traversal method.

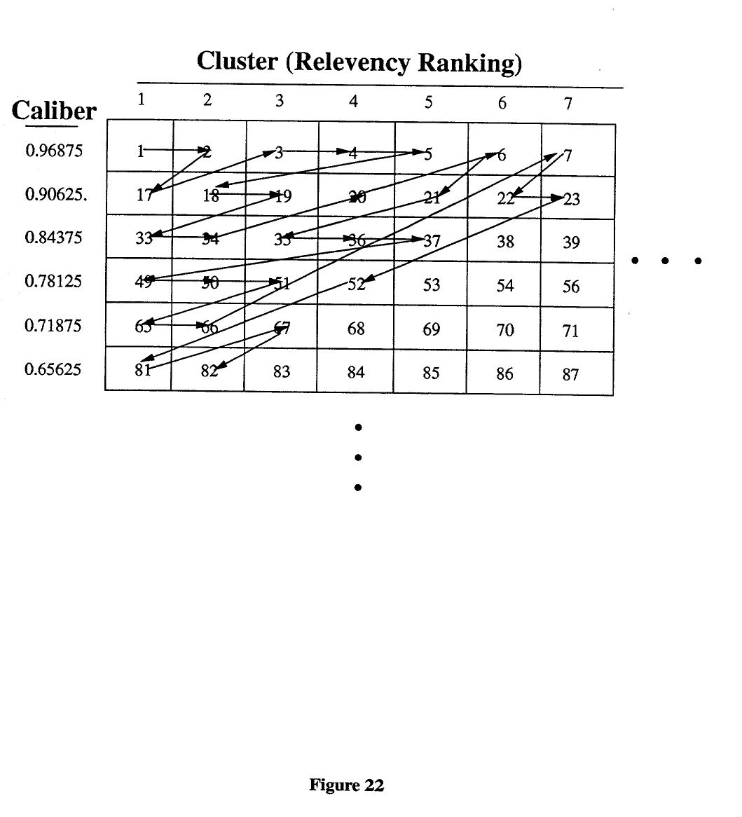

FIG. 22 sets forth a feasible path through several subsequent pixels, pursuant to this method.

For example, if the active pixel has traversed from #1 to #2 to #17 to #3, the next feasible pixels are #4, #18 and #33.

If the active pixel has traversed from #1 to #2 to #17 to #3 to #4 to #5 to #18 to #19 to #33, the next feasible pixels are #6, #20, #34 and #49.

A blended calculation based on cluster relevancy and Caliber midpoints is done for each feasible pixel, a choice is made, and the blended scores of all the threads contained therein are calculated, the threads are added to our response list.

In alternative embodiments, the value calculated for any feasible pixel is stored between iterations, so that no value is calculated twice while traversing the pixels. The final response to the user is based on the response list, sorted by the blended thread scores.

### 5. Network Configuration

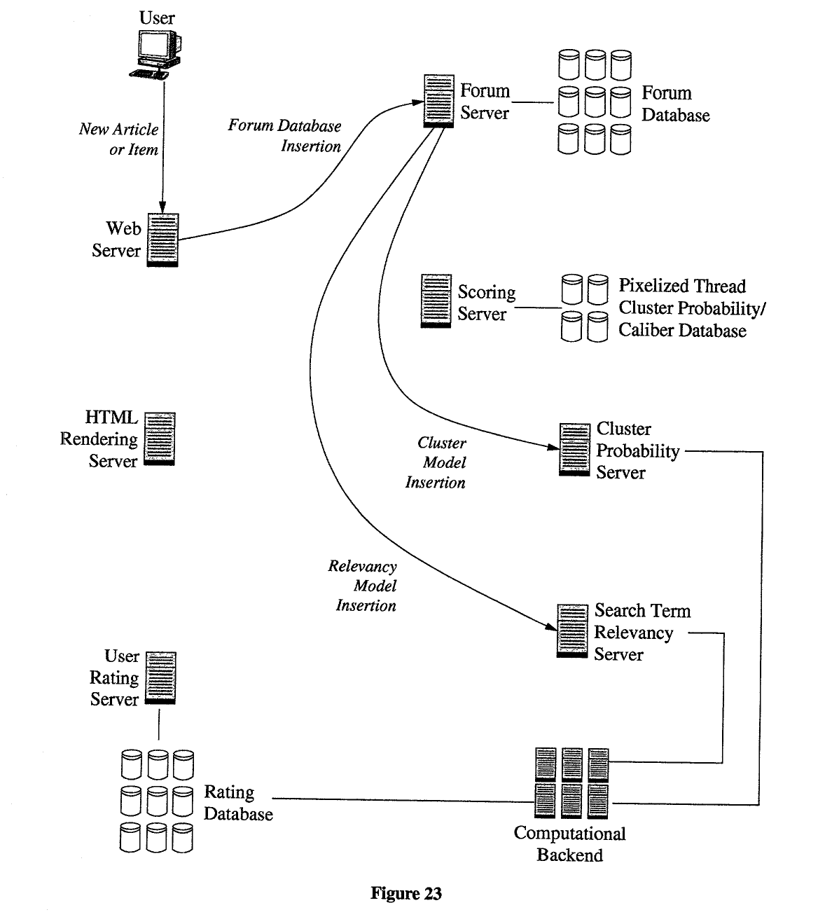

FIG. 23-26 set forth a wide area network and a series of network nodes, servers and databases in a preferred embodiment of the Invention (the “Configuration”).

In FIG. 23, an article or other item is contributed to a web server, passed along to a forum server and entered into a forum database. Concurrently, the forum server passes the item along for insertion into a cluster model, mediated by a cluster probability server supported by a back end computational cluster. In selected embodiments, the forum server also passes the item along for insertion into a relevancy model, mediated by a search term relevancy server supported by a backend computational cluster.

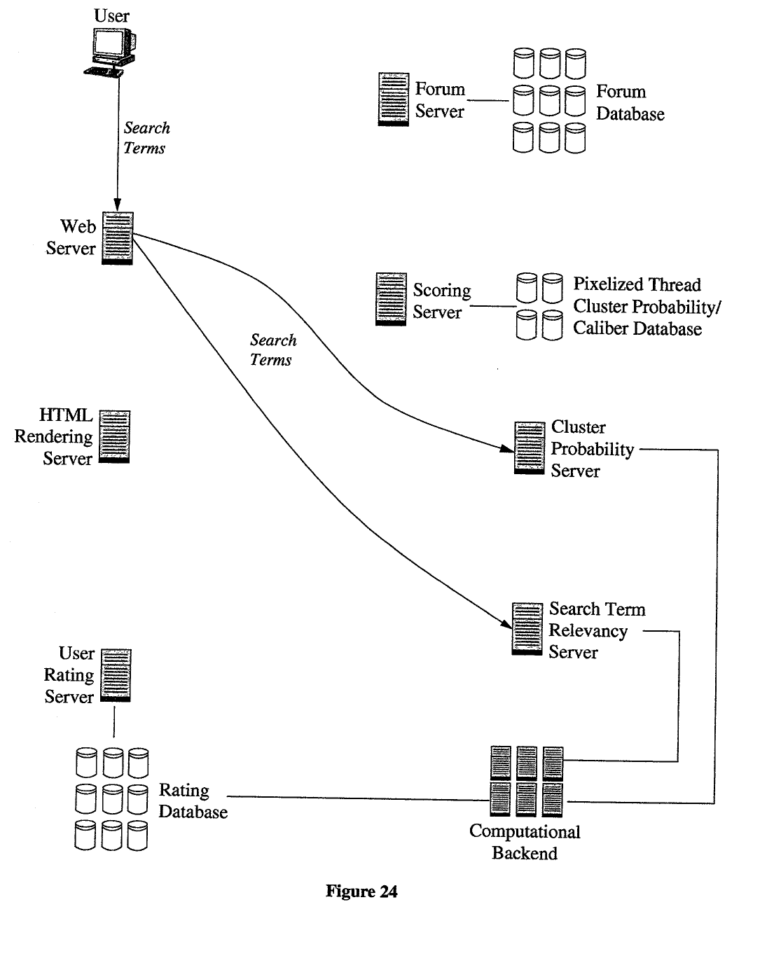

In FIG. 24, a user submits search terms to a web server, which passes the terms along to the cluster probability server and search terms relevancy server.

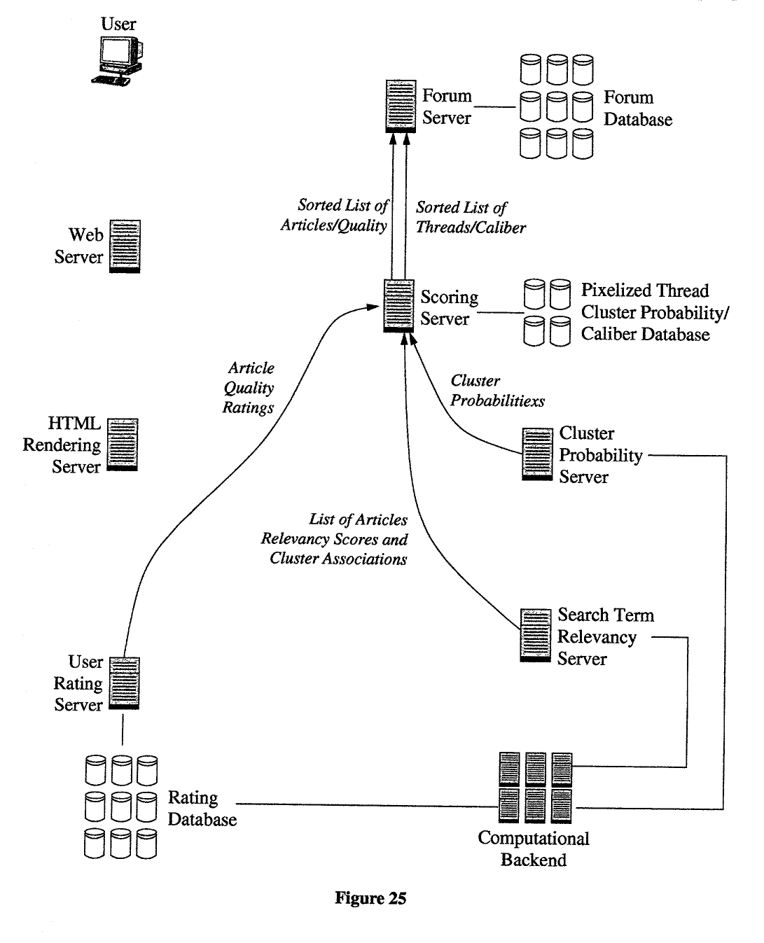

In FIG. 25, the cluster probability server delivers cluster probabilities associated with the search terms to a scoring server. The scoring server accesses a database of “pixelized” A representations of clusters and a caliber segments, conducts an efficient pixel traversal, and calculates blended values for a subset of the threads in the database. The search term relevancy server delivers a list of articles, relevancy scores and the articles' cluster associations to the scoring server. The rating server delivers ratings such as Quality and Caliber to the scoring server, for updated scoring. In turn, the scoring server delivers sorted lists of articles/Quality and threads/Caliber to the forum server.

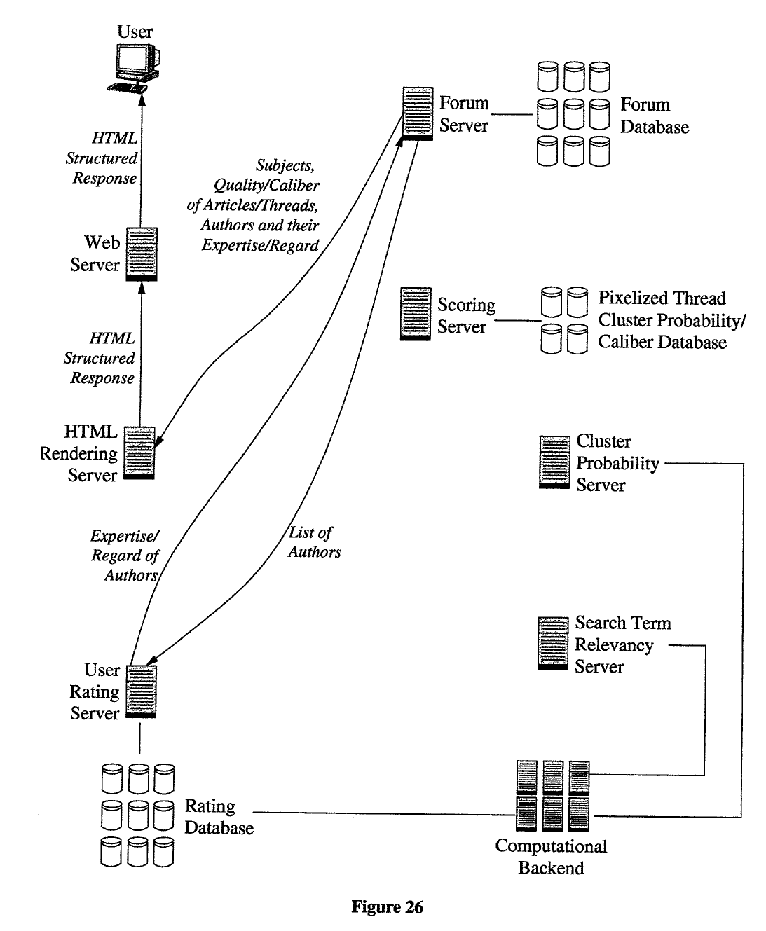

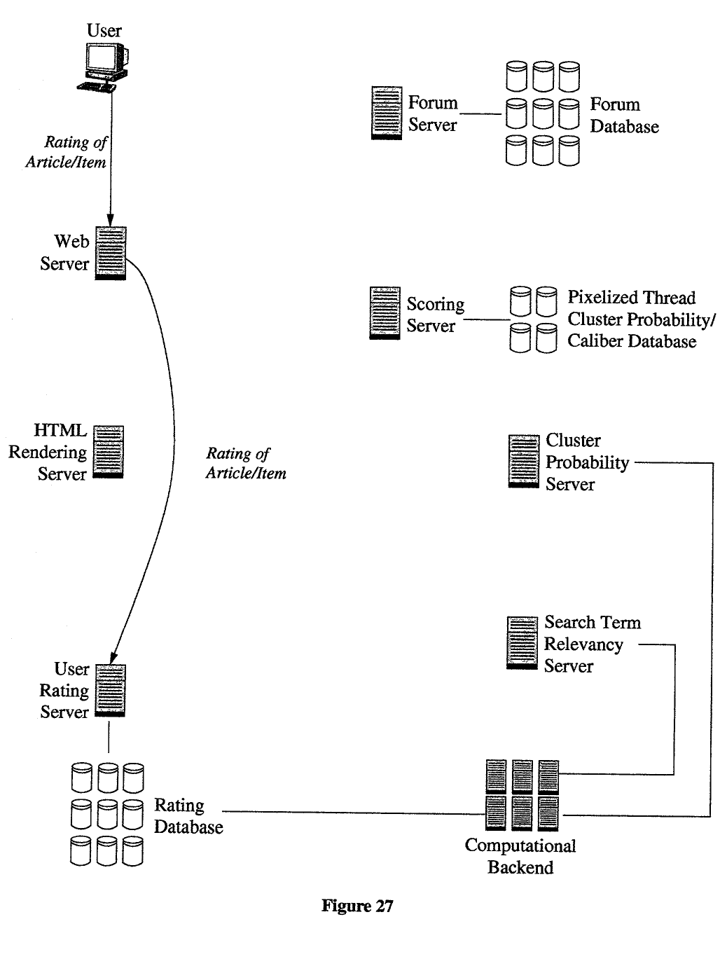

In FIG. 26, the forum server queries the rating server with the list of authors whose articles will be displayed in a fashion that will display user ratings of expertise or regard, submits subjects, ratings and structural information to the html rendering server, which constructs a mark-up language version of a list of articles, including for example information on quality and forum structure, which are then transmitted to the user.

FIG. 27 demonstrates the path through which ratings travel to the ratings server for subsequent backend analysis, updating values of expertise, regard, quality and caliber.

1) A method of providing interactive search and retrieval of content items disseminated over a computer network, comprising the steps of:
(a) receiving a plurality of content items provided by users of computers;
(b) separating the plurality of content items into a plurality of discrete classifications, in accordance with pre-established criteria;
(c) receiving at least one word from a first user of a computer;
(d) associating the at least one word with at least one classification of the plurality of discrete classifications, in accordance with pre-established criteria;
(e) disseminating to the first user at least one content item drawn from the at least one classification with which the at least one word has been associated.
(f) receiving evaluations of the at least one content item from certain ones of the users.
(g) assigning a quality rating to the at least one content item based on weightings of the evaluations.

2) The method of claim 1, wherein separating the plurality of content items is performed in accordance with at least one of word usage, word frequency, concept usage, and concept frequency.

3) The method of claim 2, wherein associating the at least one word is performed in accordance with at least one of common words, word usage, word frequency, common concepts, concept usage, and concept frequency.

4) The method of claim 3, wherein the associating the at least one word includes comparing the strength of a first association between the at least one word with a first discrete classification and a second association between the at least one word and another discrete classification.

5) The method of claim 4, wherein disseminating is based upon the quality of at least one content item, and the degree of association between the at least one word and a classification associated with at least one content item.

6) The method of claim 5, wherein quality is based upon at least one of the individual expertise of a user from whom a content item is considered and weighted ratings of the content item provided by other users.

7) The method of claim 5, further comprising:
(a) categorizing relative degrees of quality into a plurality of segments, and separating the plurality of content items according to such segments, in accordance with previously received evaluations,
(b) calculating relative degrees of association between the at least one word and each of a plurality of content classifications established in accordance with other pre-existing criteria,
(c) balancing the relative degree of association between the at least one word and each content classification, and the average quality of each of the plurality of quality segments, to assign a value to each pairing of a content classification and quality segment, and
(d) evaluating certain items according to their separation into content classifications and into quality segments, in an order based on the value assigned to each pairing of a content classification and a quality segment.

8) The method of claim 5, wherein content items are disseminated to an individual user also in accordance with the relative strength of the association between a word or series of words received from an individual user, on the one hand, and each individual content item, on the other.

9) The method of claim 8, wherein the relative strength of the association between a word or series of words received from an individual user, on the one hand, and each individual content item, on the other hand, is in accordance with measurements of common words or word usage or word frequency, or common concepts, concept usage or concept frequency.

10) The method of claim 1, wherein the associating the at least one word includes comparing the strength of a first association between the at least one word with a first discrete classification and a second association between the at least one word and another discrete classification.

11) The method of claim 10, wherein the separation of content into a plurality of discrete classifications excludes items below a certain level of quality from any classification.

12) The method of claim 10, wherein the evaluation provided by a first individual user is weighted to reflect an individual expertise rating of the first individual user.

13) The method of claim 12, wherein the individual expertise of the first individual is based on weighted evaluations by other individual users of at least one of the content items or evaluations provided by the first individual user.

14) The method of claim 10, wherein content items are disseminated to an individual user in accordance with the quality of each item and the relative strength of the association between a word or series of words received from such user and the classification of such item.

15) The method of claim 14, wherein the evaluation provided by a first individual user is weighted to reflect an individual expertise rating of the first individual user.

16) The method of claim 15, wherein the individual expertise of the first individual is based on weighted evaluations by other individual users of at least one of the content items or evaluations provided by the first individual user.

17) The method of claim 14, wherein the separation of content into a plurality of discrete classifications excludes items below a certain level of quality from any classification.

18) The method of claim 14, wherein content items are disseminated to an individual user also in accordance with the relative strength of the association between a word or series of words received from an individual user, on the one hand, and each individual content item, on the other.

19) The method of claim 18, wherein the relative strength of the association between a word or series of words received from an individual user, on the one hand, and each individual content item, on the other hand, is in accordance with measurements of common words or word usage or word frequency, or common concepts, concept usage or concept frequency.

20) The method of claim 18, wherein the evaluation provided by a first individual user is weighted to reflect an individual expertise rating of the first individual user.

21) The method of claim 20, wherein the individual expertise of the first individual is based on weighted evaluations by other individual users of at least one of the content items or evaluations provided by the first individual user.

22) The method of claim 1, wherein the separation of content into a plurality of discrete classifications excludes items below a certain level of quality from any classification.

23) The method of claim 22, wherein the evaluation provided by a first individual user is weighted to reflect an individual expertise rating of the first individual user.

24) The method of claim 23, wherein the individual expertise of the first individual is based on weighted evaluations by other individual users of at least one of the content items or evaluations provided by the first individual user.

25) The method of claim 1, wherein the evaluation provided by a first individual user is weighted to reflect an individual expertise rating of the first individual user.

26) The method of claim 25, wherein the individual expertise of the first individual is based on weighted evaluations by other individual users of at least one of the content items or evaluations provided by the first individual user.

27) The method of claim 6, wherein the individual expertise of the user from whom a content item is considered as a direct measure of the quality of such item, alone or in addition to weighted ratings of the item provided by other users.

28) The method of claim 6, wherein measurements of quality and the relative strength of associations are calculated for pre-established segments of quality and content classifications, with such calculations defining the order by which individual items in such segments are evaluated.
